(19) United States
(12) Patent Application Publication
(10) Pub. No.: US 2004/0219493 A1
(43) Pub. Date: Nov. 4, 2004

(54) Interactive learning and career management system

(76) Inventor: Nigel Jude Patrick Phillips, Melbourne (AU)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/475,437

(22) PCT Filed: Apr. 22, 2002
(86) PCT No.: PCT/AU02/00504

(30) Foreign Application Priority Data
Apr. 20, 2001 (AU) PR 4540

(51) Int. Cl. G09B 19/00; G09B 7/00

(52) U.S. Cl. 434/118; 434/350; 434/362

(57) ABSTRACT

A system and method for providing a user with information to enhance the user's learning and development. It includes the server means (6) connected to a communications network (8) and the various processing terminals (3, 4, 5, 7) used by a user and connected to the communications network (8) either directly or through a mobile communications network (9). A computer program stored in a memory of the server (6) searches information sources for the information, wherein the information sources are linked to the communications network (8) and wherein the information is relevant to the user based on a personal profile of the user. The system also includes a user electronic storage means, such as a personalised website, to which the information is forwarded for presentation to and accessibility by the user.

### FIELD OF THE INVENTION

This invention relates to a method and system of providing information to a user to enhance their learning and development.

### BACKGROUND OF THE INVENTION

In any educational or training environment generally the biggest impact on the success of an individual or an organisation is not the quality of training received but what the particular learners can apply after the training. Presently education and training, be it secondary, post secondary or in a work environment, are not equipped to successfully manage and support individual self-managed learning and application of knowledge and skill. Furthermore many small to medium sized organisations do not have formalised training and development programs in place or performance management systems that can support organisational performance and the personal and professional growth of employees. Generally many such organisations are ignorant of how they can support employees to be more productive.

Training and development begins in school systems where the need for a more targeted and individual program is required for students. This is due to the fact that applying new skills in any setting is dependent upon a complex interaction of various factors including self esteem and self opinion, self management (ability to organise, prioritise and time manage), performance management (ability to set goals and gauge progress), the actual time spent on a particular task, managing stress, health and safety issues, diet, work-life balance, tracking skill development and managing information (more easily navigate, find, organise and retrieve and obtain information).

High self esteem, structured and organised learning, focus on tasks, goal setting and managing personal issues has a significant impact upon performance, learning and the application of new skills. One of the major issues for on-line learning is maintaining learner motivation and focus especially when the learner is not logged on to a particular electronic program and where it is up to the individual to motivate themselves. The dropping out of potential and current clients, be they students or workers, can represent a significant cost to the effectiveness of learning on an individual level and to running a viable education business.

With respect to present educational training and career planning schemes that involve the use of World Wide Websites there are a number of problems or constraints that slow the growth and potential of many individuals. These include the provision of career related and education information is fragmented wherein the consumers have to visit multiple sites and often register with multiple providers, each provider supplying a piece of the education and career information jigsaw. Furthermore, existing websites are content heavy—telling the learner “what” they need to do, but low in “why” they need to do it and “how” they can improve their results. Research into consumer behaviour on the Internet suggests that in many cases consumers will not bother trying to battle through the information barrage and will ignore the particular resource. Thus many high profile educational websites have lost their popularity and even disbanded. Some websites have encountered significant problems and try to get users to return to use their services and generally websites have the disadvantage that unless the user is actually on-line connected to that website, the website resource is generally unavailable when the user is off line. In other words there is no further tuition or learning environment available to the user.

Existing web based learning programs do not offer the best practice available in terms of meeting the individual learning needs of users and using the technology to make learning fun, more interactive and easier. At present there are no programs in place that facilitate the cyclical education to work transition process. The most efficient and effective management of education to work transitional processes is at the individual level. However, our present educational system creates learners who are dependent upon an “expert” who has the tools and expertise to assist them. Interdependent learning requires that learners have the knowledge, tools, processes and support to assist them in managing their own career and learning journey. The process of career and learning management is most effective when it is pro-active rather than reactive. Present systems do not lend themselves to create proactive and interdependent learners.

The present invention provides a method and system that seeks to overcome one or more of the above disadvantages or constraints of present systems by providing an interactive on-line and off-line program for the user that establishes, maintains and develops a particular learning program for the user in a substantially more efficient manner than previous systems.

### SUMMARY OF THE INVENTION

According to a first aspect of the invention there is provided a system for providing a user with information to enhance said user's learning and development, said system comprising:

a server means connected to a communications network, said server means having memory means, processing means, and data storage means;

processing terminal means connected to said communication network for accessing said server means;

wherein computer program means stared in said memory means of said server means searches information sources for said information, said information sources being linked to said communications network and wherein said information is relevant to said user based on a user profile data;

said user profile data including user psychometric data and user personal profile data; and

a user electronic storage means for said user into which said information is forwarded for presentation to and accessible by said user.

The user profile data may also include user behaviour data.

When said user accesses said user electronic storage means, said computer program means may transmit one or more visual messages to said user at predetermined times to inform, remind or alert said user to information pertaining to said user's learning and development. The one or more visual messages may be transmitted to said user using an intelligent agent.

The personal profile may be entered and stored in a user profile database and include information on said user, such as biographical information, academic information, personal interests, etc. The database may be initiated by a first module, being a user profile module, and use psychometric data on said user.

The memory means of said server means may store a second module, called a career manager module, which is based on the user personal profile and searches for suitable career options for said user.

The memory means of said server means may store a third module, called a performance manager module, which based on said personal profile, may track the user's development toward established learning and career goals. The memory means of said server means may store a fourth module, called a learning manager module, to assist said user to plan and learn effectively.

Each of the modules may be tailored to suit the user such that said user can access said user electronic storage means, which may be a www site, to be presented with information relevant to their learning and development.

The communication network may be the Internet and each of the computer processing terminal means may be PCs, notebook computers and the like, or wireless devices linked to said communications network through a wireless communications network.

According to a second aspect of the invention there is provided a method of providing information to a user to enhance their learning and development, said method using a communications network to which is linked a server means having memory means, processing means and data storage means, and a processing terminal means, said method comprising the steps of:

searching, via computer program means, information sources linked to said communications network for information relevant to said user and based on a user profile data;

said user profile data including user psychometric profile data and user personal profile data;

providing said user with access to a user electronic storage means;

storing said information in said user electronic storage means, such that on accessing said user electronic storage means, said user is presented with said information, being information that is relevant to said user's learning and development.

According to a third aspect of the invention there is provided a computer program element comprising computer program code means to control a server means to execute a procedure for providing information to a user to enhance their learning and development using a communications network by:

searching information sources linked to said communications network for information relevant to said user;

wherein said information is relevant to said user based on user profile data;

said user profile data including user psychometric profile data and user personal profile data;

providing said user with access to a user electronic storage means;

processing and storing said information in said user electronic storage means, and presenting said information to said user on accessing said user electronic storage means.

According to a fourth aspect of the invention there is provided a computer readable memory, encoded with data representing a computer program for directing a server means to execute a procedure for providing information to a user to enhance their learning and development using a communications network by:

searching from information sources linked to said communications network for information relevant to said user;

wherein said information is relevant to user based on user profile data;

said user profile data including user psychometric profile data and user personal profile data;

providing said user with access to a user electronic storage means;

processing and storing said information in said user electronic storage means, and presenting said information to said user on accessing said user electronic storage means.

### BRIEF DESCRIPTION OF THE DRAWINGS

A preferred embodiment of the invention will hereinafter be described, by way of example only, with reference to the drawings wherein:

FIG. 1 is a schematic block diagram of a system used by one or more users to create their own website and to provide the users with information to enhance their learning and development;

FIG. 2 is a schematic block diagram of the various modules used in the system and accessed via a personalised on-line website for each user and of modules or components of a desktop management interface;

FIGS. 3a through to 3d show screens that allow a user to input information that is used in a personal profile database;

FIG. 4 is a further screen allowing a user to input preferences as to how best they learn;

FIG. 5 is a screen allowing a user to select from a number of options issues that concern the user which goes into their personal profile;

FIG. 6 is a block diagram showing the various modules forming part of a career manager module;

FIG. 7 is a screen showing links to various occupations that a user can access;

FIG. 8 shows a screen detailing information about an occupation that was accessed via FIG. 7;

FIG. 9 is a screen produced on accessing a skill bank module of a performance manager module;

FIG. 10 is a screen providing further details on an educational institution that was accessed via a link in FIG. 8;

FIG. 11 is a screen detailing links to various potential employers;

FIG. 12 is a screen showing various contacts for a user accessing a support module of the career manager module;

FIG. 13 is a block diagram of the various modules forming the performance manager module;

FIG. 14 shows access to a number of screens via an induction module of the performance manager module;

FIG. 15 is a screen showing the position description of a particular position accessed through a job description module of the performance manager module;

FIG. 16 shows an account statement of work experience done by a user and accessed through a skill bank module of the performance manager module;

FIG. 17 is a further screen taken from the skill bank module detailing a competency statement of the user;

FIG. 18 is a block diagram showing the various modules that make up a learning manager module;

FIG. 19 is a screen showing an intelligent agent providing a reminder notice to a user;

FIG. 20 is a table showing work that is to be achieved on a particular day by the user and which has been initiated through the intelligent agent;

FIGS. 21, 22 and 23 show screens with the intelligent agent providing extra information to a user relevant to their learning and development.

### DETAILED DESCRIPTION OF PREFERRED EMBODIMENTS

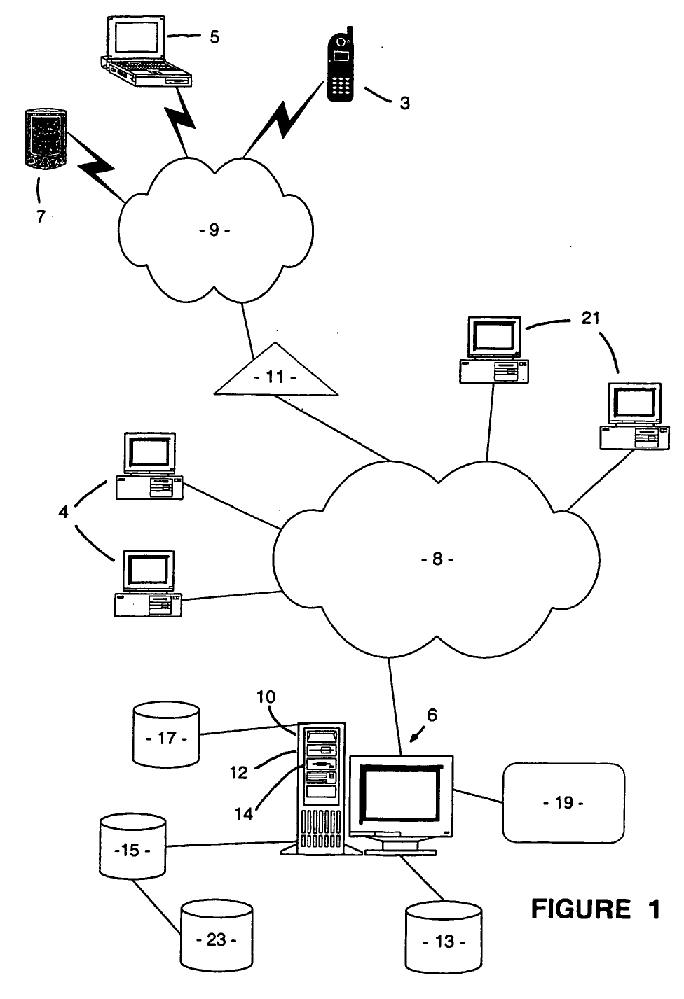

Shown in FIG. 1 is a communications system 1 used by various users to create their own database (which may be a user electronic storage means or their own website) that is specific to their particular learning and developmental processes. A user will typically use a processing terminal means 4, which is suitably a PC, and access a server means 6 through a communications network 8, which may be the Internet. The server means 6 comprises processing means 10, memory means 12 and data storage means 14.

A user may also use a processing terminal means in the form of any one of the mobile processing devices 3, such as a mobile telephone, device 5 in the form of a personal digital assistant, or device 5 in the form of a wireless PC. Each of the processing devices 3, 5 and 7 are linked by radio communication to a mobile telephone network 9, which in turn is linked to communications network 8 through gateway 11. Each of the devices 3, 5 and 7 may be able to transmit and receive information via the networks 9 and 8, where network 8 is the Internet, including text documents which are embodied with hypertext mark-up language (HTML) tags that provide page formatting links for display by a web browser program which is installed in each of the mobile devices. The information and accompanying control and formatting information my be exchanged between the devices and server 6 by means of a standard web server protocol such as HTTP.

The wireless application protocol or WAP specification or a third generation specification may be used to enable the transfer of information from the mobile devices to the server 6.

The infrastructure supporting the system will generally be based on open standards, for example the operating system used may be Unix or Linux or Windows NT. Databases that are used may be Oracle Relational Databases and applications may be written in Java/JSPIC++ and may have fully documented and accessible application programming interfaces. The system is configured to be capable of handling and serving both structured and unstructured content. An example of structured content is derived from relational database tables and similar repositories and an example of unstructured content is free form text, video or audio.

The server 6 may also be represented as a content authoring and management engine that has Virtual Team Room (VTR) hosting capability. Content authoring and management is the collection of processes by which content can be sourced which may be either from local authors or from external providers or repositories. The content is passed through a predefined set of work flow controlled mark up and approval steps, published and then finally archived. Virtual Team Rooms or VTR's provide for either ad-hoc or structured and managed collaboration between users of the system. This facility will, for example, allow communication and elaboration between groupings of individuals where the groupings are dependent on geography, career path or where a particular issue is being resolved. Part of the server or engine 6 is linked to an on-line content delivery and display engine. On-line content delivery applies presentation logic, that is the formatting or “look and feel” to the content elements. By separating the presentation logic from the core content, the system is able to dynamically apply different formatting to a given content item as a function of the context in which that item is being used, or of the function of the audience using the content.

A first database means in the form of a user profile repository 13 contains user profile data defining individual characteristics of system users. This data is collected and stored during user interactions with the system and can subsequently be used to personalise and target the delivery of content to a user so as to improve its relevance to that user. A second database means in the form of a local content repository 15 is used to store locally authored content. It stores content that has been localised. For example, information could be presented that is relevant to someone in one location but different to information presented to another person in another location. Thus, a local business could advertise for employees with specialist skills or knowledge within their locality, region, state or country. A third database 17 is used to store user behaviour statistics. The collection of information, such as usage statistics and demographic date, builds a valuable database resource which can be used not only to target specific campaigns and individual market segments but also builds a valuable data asset which could be on-sold. Also, linked to the server means 6 is a CD-ROM production engine 19 which provides for off-line published content whereby a user may in their own time use the information on any one of the CD ROMs provided. The benefit of CD ROMs based delivery includes the ability for users to access data independently of the network connection. Users are more likely to purchase the service if that service includes tangible assets such as a CD ROM. However, the benefits of on-line delivery are not to be discouraged as they provide an ability to ensure up to date information, the opportunity to engage in real time information transactions. Furthermore, the data that can be collected about usage patterns and profiles is invaluable to the operators of the system.

A content syndication engine is also linked to the server means 6 which processes and provides content to third party publishers, for example franchisees or government authorities or other agencies for publication on their websites. Content syndication is analogous to the syndication of media assets and this syndication differs from traditional content exchange in that the system operator retains control over the frequency within which content is sent to these third party publishers and it allows the system operator to control, on a case by case basis, the exact content that is supplied to each third party. The franchisees or other agencies may be supplied with content via the server 8, communications network 8 and to computing processing means (PCs) or equivalently servers 21 used by the franchisees or agencies. The content syndication effectively extends the system operators web presence in a manner which allows the source publisher to retain overall control whilst allowing third party advisers flexibility to brand the content received from the source publisher. Finally, a data mining engine 23 is linked to the local content database 15 and is used to discern all actionable insights from the usage statistics database 17. The engine 23 applies analysis tools to the data stored to determine trends and to establish relationships that would not otherwise be obvious. It also provides actionable feed back to the overall content management process via schools, agencies, and service providers for example.

An important part of this invention relates to a media business unit, whereby media content associated with the invention is scheduled according to demands of

the user. It is a means of creating a demand and providing multiple access channels provided by this invention, to users grouped by a common feature or grouped geographically or regionally. For example, media programs, through television radio and the print media can be directed to a group of people who may have experienced redundancy and the media programs are designed to meet their needs. Another example is where large groups of country clients for example, might want to be involved in the IT industry and therefore the media programming surrounding this invention will be responsive to those peoples needs within their region in relation to IT.

The invention uses the media business unit and works with television, radio and the print media to communicate the value proposition of the invention, build brand equity and create demand for products and services derived from the invention.

It will result in the following benefits:

Generating advertising revenue from all channels;

capturing a larger share of education advertising budget and delivering the same amount of information that present educational institutions provide to respective students via use of the invention thereby dramatically reducing costs;

minimising the need for additional marketing expenses and therefore reducing the cost of customer acquisitions;

creating demand, providing multiple access channels for products and services derived from the invention;

generating a more compelling value proposition for advertisers, alliances and consumers;

driving at attitudinal change in the student or parent and employment markets; and

creating a catalyst for behavioural change towards developing the habits that lead to a work live success across the population.

The radio program has two potential formats:

1) A pre-recorded studio produced component lasting approximately 3½ minutes with for example, a news presenter as a host.

The presenter would interview a wide range of guests regarding educational issues, employment, training or business opportunities. These segments will be professional, snappy and informative.

2) A half-hour live broadcast, again hosted by a news presenter and discussing similar issues. The extra time would enable the topics to be explored in more depth. This production would be interspersed with music and would also enable listeners to contribute via talk back.

With regard to a television program, it will be based upon the same content as the radio program but delivered in the format of a lifestyle or infotainment program. It shall provide an informative and entertaining insight into key education and career issues and may at the same time be amusing.

With regard to the print media option, this will provide specific benefits, particularly when integrated with radio content. The benefits include cross promotion of media content, increased publicity and content coverage, generating large amounts of interest in a proposition provided by the invention, increased advertising revenues, broadening of the advertising markets and enabling employers to advertise job vacancies at a much lower cost than presently available.

The system gathers programming data from clients or users, where for example the system maps trends across different user groups such as a high interest in information technology with reference to the previous paragraph. Thus, the media, being print, television and radio run programs based upon audience interest in specific regions or localities. The technology of the system allows people to purchase products at special prices, and therefore people go back to the technology and hence advertisers are provided with accurate statistics on how successful their advertisements are. Furthermore, the system or technology also allows to map specific areas of concern in different regions. For example, some people preparing to move to the city to study at university will need accommodation, cars, books etc. All these can be targeted at specific vertical markets and achieve much higher conversion rates in terms of sales.

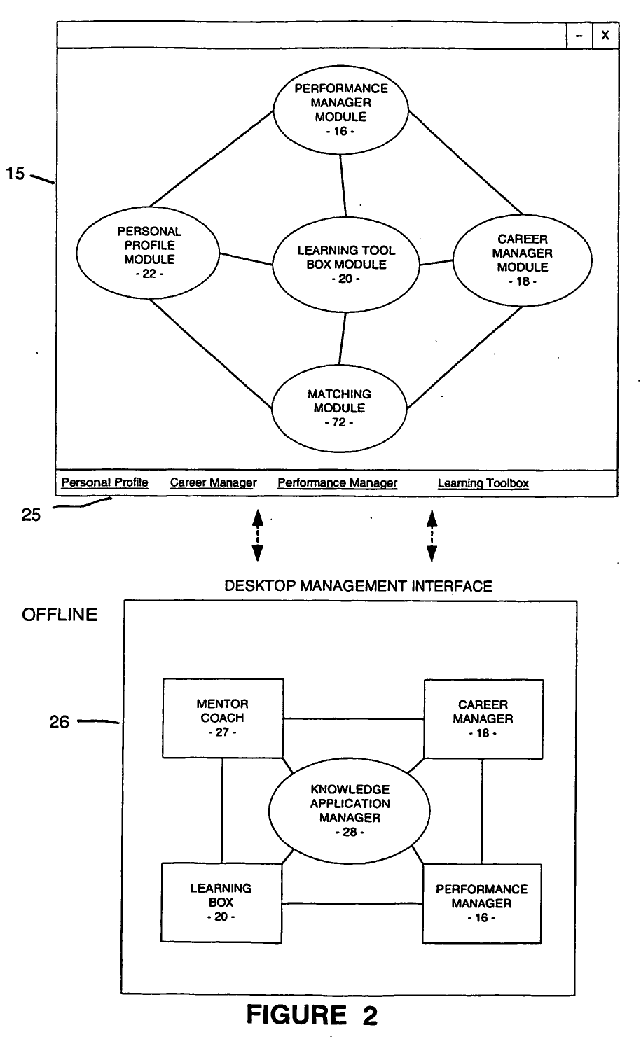

With reference to FIG. 2 there is shown a personalised on-line website 15 developed specifically for a particular user and includes access to a number of modules including a performance manager module 16, a career manager module 18, a learning manager and learning tool box module 20, a personal profile module and database 22 and a matching agent module (or career match module) 72. Each of the modules 16, 18, 20, 22 and 24 may be stored at server 6. Links 25 to each of the modules 16, 18, 20 and 22 is also available. Linked to the personalised on-line website 15 is an interface, more particularly a desk top management interface 26 which has at its core a software program known as a desk top mentor or guru (DTG) or a knowledge application manager (KAM) 28. The KAM 28 and desk top toolset integrate with the on-line website 15 to maintain a database of information off-line for individual user learning and career planning referral and reference. The software module 28 links to the various databases and other modules within the system and searches, extracts and processes relevant information for the user. The software module 28 has the ability to intelligently interact with a website and the number of databases to install its specific information and resource tools upon the users desk top PC 4 relevant to the needs of that particular individual. This process builds the PC based desk top management interface database which thereby enables an artificial intelligence engine to manage the information resourced to assist the user to utilise, learn and take action based upon set criteria. The personalised website 15 and desk top management interface 26 represent two interdependent educational and knowledge management engines that work together to support a fully interactive, integrated and comprehensive process that the user may use throughout their learning experience. The mentor coach module 27 performs similar tasks to the intelligent agent. It understands the user in terms of psychometric and personal habits and uses this knowledge to train the user and present suitable or pertinent information at suitable times to the user. This can be used to boost self-esteem and keep the user aligned with their performance goals or to remind them of a priority or important activity to do.

A feature of this system includes live-updates which maintains a desk top presence of all key customised information required for the learning, career and performance needs of the user or individual. When a user live-updates the program, data is collected as the on-line search engines seek out relevant information pertinent to the users needs and wants. Such information provides an extremely valuable database market knowledge that has utility for a number of end users. The information has significant value within the following areas:

1. planning subjects and course across all educational providers;

2. workforce planning within educational institutions;

3. evaluating educational programs;

4. tracking student destinations and labour market trends; and

5. evaluating effectiveness of labour market programs and broader social services.

The personalised website for each user provides the core information components required by the user and each live update session allows for the user to easily update their “intelligent agent” desktop system with the latest information required to manage their career and learning needs.

As an example, a user having undertaken a career plan through using the invention, identifies a strong interest in horticulture. Unsure about what careers exist in horticulture and how to enter the career, the user enters a search through the desktop mentor, and which search is conducted by the career match module 72.

The next time the user live-updates the desktop, the software module identifies and loads into their database, a series of media programs both archived and coming up relevant to the users needs. Additionally, the client is informed of a competition opportunity of winning a work experience program.

Upon viewing the program, the user is directed to the website where they complete an on-line application, providing real-time program feedback and evaluation. At this point, the user is assessed as to their need to consult with a counsellor to clarify and develop the employment characteristics required for this career and to put in place a study plan to ensure that they are on track with entry requirements.

On the personalised website of the user, there may be displayed a media hyperlink, counsellors hyperlink and a technology hyperlink. By clicking on the media hyperlink, the user will be directed to a screen that provides information as to media events coming up and has the option for going into links associated with television, radio or the print media.

The system provides an education resource platform that allows educators/managers to access information on career preferences, class room learning styles, user support needs for planning and educational purposes. It also allows educators to share resources, techniques and strategies in an on-line forum. Information from the system can be targeted to or accessed by other agencies such as recruitment agencies, job sites, government agencies and industry groups, employer groups and individual employers. It is also ownable to education, training and development providers and may also provide community links and other resources.

Each of the modules 16, 18, 20, 22 and the software program 28 are designed together to fully integrate with and support the end user personal requirements whereby these modules share, interact with and manipulate information to facilitate the education to work transition needs of a user.

The personal profile manager module and database 22 captures the users biographic, demographic, education/experience information, achievements and psychometric information required for careers and education management. The career manager module 18 utilises information from the module 22 and undertakes career matching, identifies educational and training opportunities, provides job market and recruitment information, identifies appropriate support agencies, builds work experience and finds employment on behalf of the user. The module 18 also explores and validates specific career options, identifies the most appropriate pathways, links the user with suitable employers and support agencies. It also develops strategies to assist the user to pursue their chosen pathway. The performance manager module 16 assists the user to develop a personal mission statement and aligns this with their job description. It also assists the user to undertake induction processes, performance appraisals, identifies professional training and development opportunities, builds employability via the user's skill bank, to be hereinafter described and develops a competency based resumé aligned with suitable career pathways, it provides a link between education and work enabling the user to manage their own performance to meet specific job relevant key performance criteria.

The learning manager and learning tool box module 20 supports the user to remain focused upon learning outcomes and provides a full range of learning tools to maximise the success of on-line/off-line learning experiences and outcomes. The learning manager develops effective meta-cognitive learning strategies including planning, monitoring and goals setting for on-line and off-line learning.

The software module 28, described as the desk top guru or knowledge application manager links with the other modules to provide the user with personally relevant motivational expressions, poems, ideas and opportunities to develop positive internal conversation as a key driver of high self esteem. It also serves to remind or trigger the user of their learning career goals and coaches them regarding their progress, through the use of an intelligent agent that appears with a message on the screen of the users PC. This module 28 forming part of the desk top management interface forms the epicentre of the entire system lifelong learning and career management program.

Personal Profile Manager Module and Database

This module 22 creates a user profile database for the user by the user entering particular data which then subsequently gets stored on the user's own website stored at the data storage means 14 on server 6. Typically the user will access a main website at server 6 in order to prepare the database using this module by using their own terminal or PC 4. Once the user has accessed the main page or home page of the main website a hypertext link may be provided to enable the user to prepare the database of information based on this module. Thus once the user clicks on a hypertext link in order to prepare the database, the processing means 10 under instruction from a program stored in the memory means 12 will facilitate the necessary web pages to be presented to the user for that user to complete the user profile database. The database will have entered therein information pertaining to the personal, bio-graphic and demographic records of the user, a complete personal achievement and an experiential information record and a range of psychometric assessments and measures that are consistent with the needs of the user.

The user is able to access the database, via a PIN and password, in order to view or update information such as education and work-life circumstances as they change or develop. This database will provide a foundation platform for interrelationships between each of the other modules in the system.

Once the web pages are downloaded to the user's computer 4 they undertake a process to record their personal biographical information including family members, important relatives and friends details. In addition there is a request to the user to enter and validate particular achievements, academic information, interests and other information that will provide the overall system with an enriched individual profile of the user upon which to manage their learning and career needs. The module or software used to construct the personal profile utilises a range of psychometric assessments. This particular program or module adds in to the overall system how the psychometric assessments are utilised in order to add value to the user's learning program. A particular reporting process called Factor Analysis Feedback or FAF has been found to be the best method to date for psychometric and other education feedback available for on-line learning. The FAF breaks up information groups into categories and each category into discrete elements that deliver the feedback in a way that enables the user to make a decision based upon each specific element. In this manner the user develops much greater appreciation of their personal uniqueness as they get to choose the information that relates to them and leave out information that does not relate to them. This provides the user more autonomy over the purpose and outcome of the learning experience. Furthermore the FAF allows the system to more completely understand and manage the specific learning and career requirements of the user by gaining a better understanding of their personal choices in relation to the psychometric and learning information. This system of user choice is a primary cognitive process in interactive learning and educational engagement.

Examples of FAF are provided for career feedback information utilising the Myers Briggs Type Indicator (MBTI) assessment tool. This example categorises the feedback under the four headings:

1. I will find increased career satisfaction in doing work that . . .

2. My work related strengths include . . .

3. Areas that I plan to develop include . . .

4. Other people usually see me as . . .

Upon completion of the MBTI the users are prompted to seek the results of their assessment to answer and learn more about the question “Who am I?”

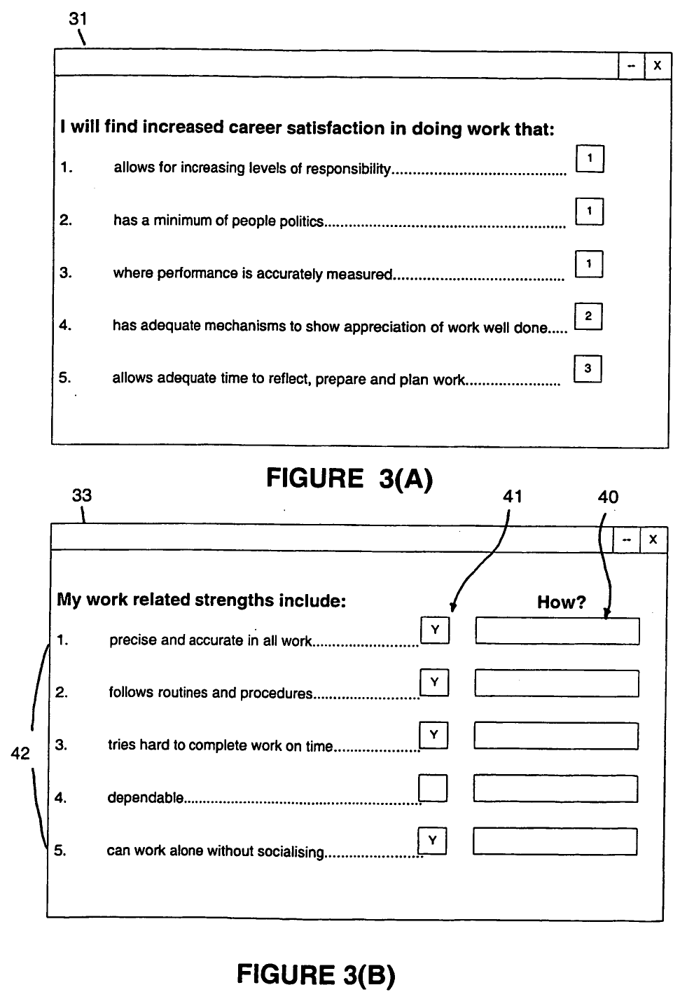

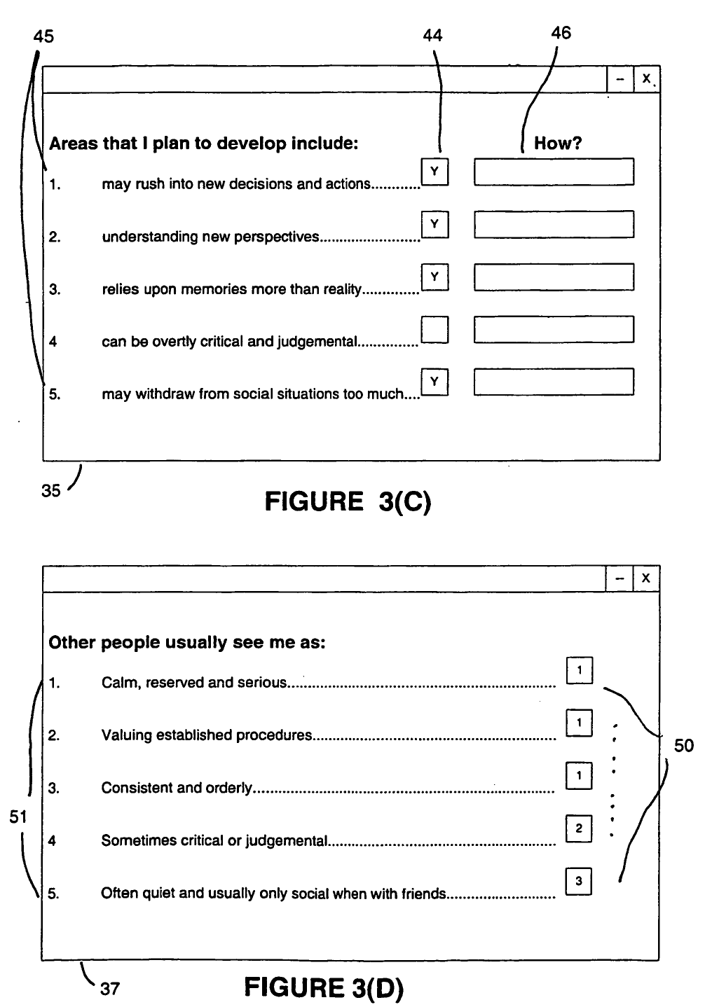

Shown in FIG. 3(a) is a screen 31 that is used to provide the user with feedback about their personality preferences after they have completed the on-line MBTI assessment. Thus it provides a range of choices to answer the statement “I will find increased career satisfaction in doing work that” which provide career feedback information. Each of the choices may be answered by using a numbering system 1, 2, 3 where 1 is a characteristic that is most important and 3 is least important. By making a user work through this feedback method the system databases capture a complete profile of the preferences and unique attributes of the user. The information is then used to intuitively identify support programs, opportunities for development and learning and career development that may otherwise go unnoticed. The system shares this information on-line and off-line so that the learning and development of the user is integrated and holistic.

Each of the individual alternate additions to the statement “I will find increased career satisfaction in doing work that:” is identified and listed as an active field so that the user can accept or reject features that relate or don't relate to them. Five responses are required from the user in the screen 31 whereby the boxes enable the user to insert the number 1 to 3 as described above in response to that particular characteristic. By numbering the responses, the ability to interact with each attribute of feed back enables the user profile database to be more intelligently informed about the uses and needs.

This reporting process assists the individual to identify their strengths and the strategies that they can use to further maximise and develop their knowledge and skills. It has significant impact upon the self esteem as the user learns about and develops a better understanding of their individual strengths.

Shown in FIG. 3b is a screen 33 that enables users to select options in answer to the statement “My work related strengths include:”. Drop down menu boxes 40 link to a dynamic database that identifies generic examples of demonstrated strengths that are applicable to the particular characteristics 42. By providing the user with options or choices the program intimately understands and matches the individual preferences of each user. The aggregated preferences can also be used in schools, organisations, social planners and research agencies.

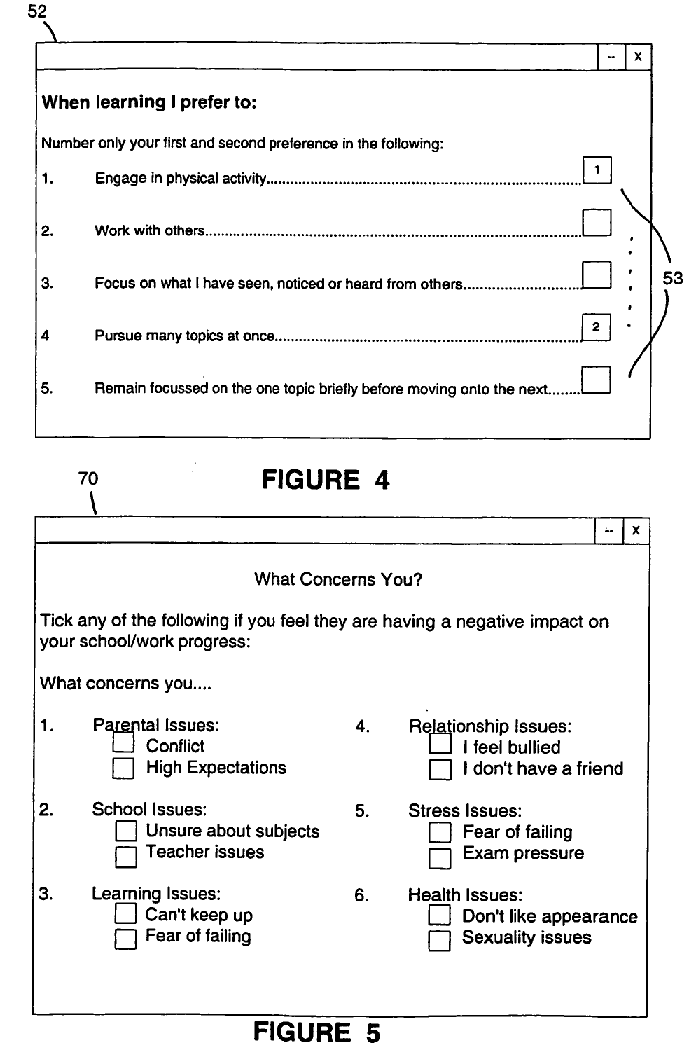

Each of the strengths characteristics 42 is specific to generic personality preference but each individual gets to choose the elements that most relate to them and add to this list anything that may be absent. This also applies to any one of the list of characteristics shown in FIGS. 3c and 3d and FIG. 4. Thus, a user may tick one of the boxes 41 to indicate agreement to the identified strength characteristic and alongside in another box 40 identify generic examples as discussed above.

With reference to FIG. 3c there is shown a screen 35 which shows characteristics 45 that a user may choose in answer to the statement “Areas that I plan to develop include:” Again using the check boxes 44 they can select those characteristics that are applicable to them and in the drop down boxes 46 generic examples of development strategies are identified and provided. The drop down boxes 46 are linked to a dynamic database to provide said identification.

Shown in FIG. 3d is a screen 37 that shows options or characteristics 51 available to the user in answer to the statement “Other people usually see me as”. Again boxes 50 are provided to the user where they enter a number from 1 to 3 where 1 is identifying a characteristic most like the user, and 3 identifies a characteristic least like the user. Five characteristics 51 are listed to derive responses from the user.

The information feedback under learning styles is broken down into key question categories that include:

How do I prefer to learn?

What learning strategies work best for me?

What learning strategies do I need to develop?

What information would improve my learning process?

Each question is then further broken down into discrete elements from which the user is required to choose. For the example shown in FIG. 4 there is a screen 52 that shows how the process works for the first question identified above. Thus, this particular user has identified as their first preference that they prefer to engage in physical activity when learning and the second preference is that they pursue many topics at once. Their identification and prioritisation of these elements in boxes 53 further develops the user's understanding of how they learn and links the software module 28 for coaching purposes to the user at later times.

A further important assessment function relates to the user's personal feelings of well being. The aim is to pro-actively identify and address the various factors that can have a negative impact upon the day to day undertakings of a young person in the transition from education to work. While the user will remain anonymous, aggregated data is available to the school, institution and agencies so that programs can be developed and delivered to address emerging concerns.

Thus shown in FIG. 5 is a screen 70 that allows users to select options about what sort of issues concern them, for example, parental issues, school issues, learning difficulties, relationship issues, stress issues and health issues. Thus schools and agencies are provided with accurate aggregated data upon which to plan resource and service provision. The data feeds a career manager database, associated with career manager module 18, and via the support module 74 (see later) identify the agencies, services and personnel to assist the user. Additionally the software module or program 28 will provide specific coaching to assist the user to address the issues identified in the screen 70 that they have selected to alleviate the impact upon education and career progress.

Career Manager Module

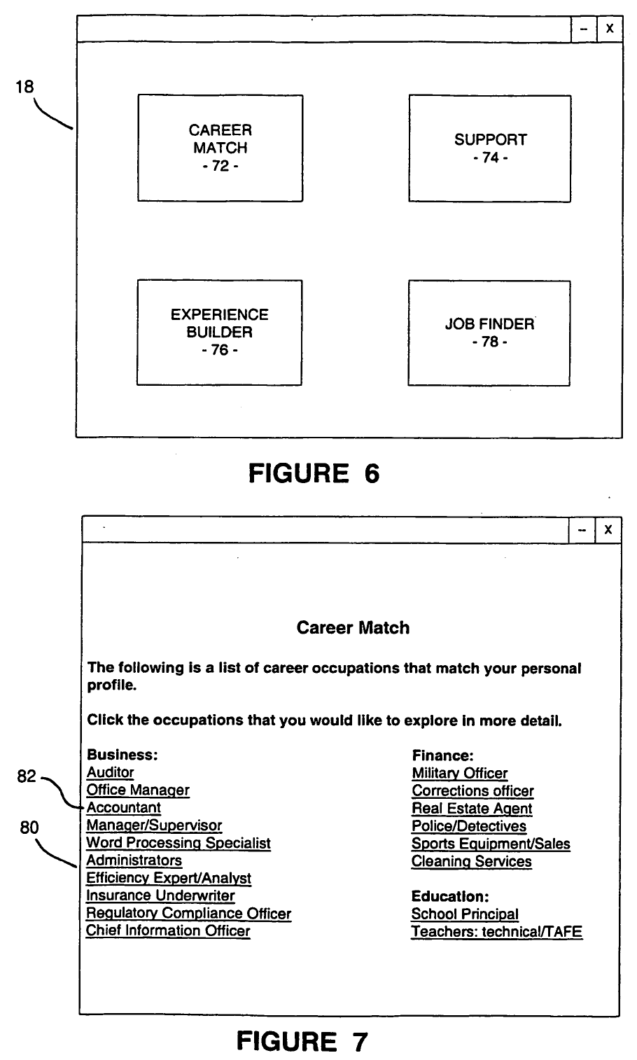

The career manager module 18 is stored in memory means 12 of server 6 and is configured for the user for use on his or her personal website. It has four functional modes identified in FIG. 6. Firstly a career match module 72, a support module 74, an experience builder module 76 and a job finder module 78. With reference to the career match module 72 it matches the user with occupation choices according to their personal and psychometric profiles entered in the personal profile database and enables the user to explore, validate and prioritise occupations to which they feel most interested. A key feature is the functional ability to identify occupations about which the user is currently aware, occupational choices they may not have been considered or occupations that have only recently emerged in the job market.

The career match module 72 has the essential function of seeking career related information that the user has specified on their desktop or via the website and then seeking this information for the user once they have live-updated. The information may take some time to find, and therefore the website will send a message, such as an SMS or email to the user to go to the website and retrieve this information, again via live-updating so that they can use it on their desktop. Furthermore, the matching agent aligns the career and personal profile of the client with suitable careers/experience, learning options that meet specified criteria. It is the link that joins the user with the vast body of information that is available over the Internet.

A key component of the career manager module 18 is the way it allows the user to gain a complete understanding of the occupation within the job market and to easily identify the educational and training requirements for the chosen occupation. These requirements can form barriers to entry and this career manager module addresses these traditional barriers by identifying alternative paths and providers so that the student or user has options between traditional and non-traditional entry to occupations. Job market information provides employer information and profiles on a local, regional and national level wherein job market data such as income levels and skill demand and employer links and networks are provided. Auto respondents send users up-to-date information pertinent to the specific employer. Thus the processing means 10 on server 6 undertakes a search of other websites to match employer information and profiles to the personal profile of the user and store the results on the user's own website for easy access by the user.

The support module 74 enables the user, to by clicking on an appropriate link, to identify and access education in career support agencies, such as job network agencies, pathway negotiators and others to market themselves to specific user groups. Thus by clicking on a hyperlink to the support module 74 a search is then conducted to enable the user to make such identification and access.

Experience builder module 76, accessed by a hypertext link, aligns the career pathway of the user with work experience options provided within a community and employment setting and once again uses the search engine based upon keywords to find relevant options to the user. Work experience programs have clear on-line guidelines and formal certificates of achievement. The value of experience is further enhanced via links with the Performance Manager Skill Bank database and Appraisal modules to be hereinafter described.

The job finder module 78, accessed by clicking on an appropriate link, brings to the attention of the user local and regional employment opportunities. These can be applied for via the Performance Manager Resumé function to be hereinafter described, or can be stored for research purposes. Together all of the four modules that make up the career manager module provide a total solution to manage career development and change.

Career Match Module

As mentioned previously the personal profile manager module 22 stored in the server means 6 generates user profiles that utilise the personal and psychometric information databases for each user. For each set of key data within the personal profile of a user, specific career pathways are assigned. These are listed as hyperlinks that enable the user to explore information about the career to gain a better understanding of what the career involves and may offer.

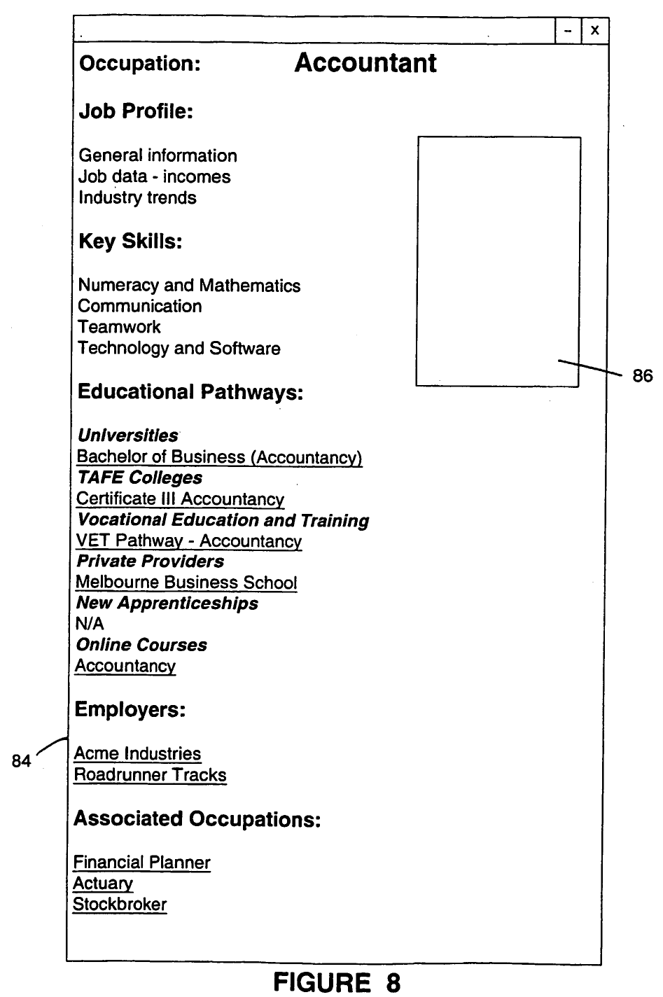

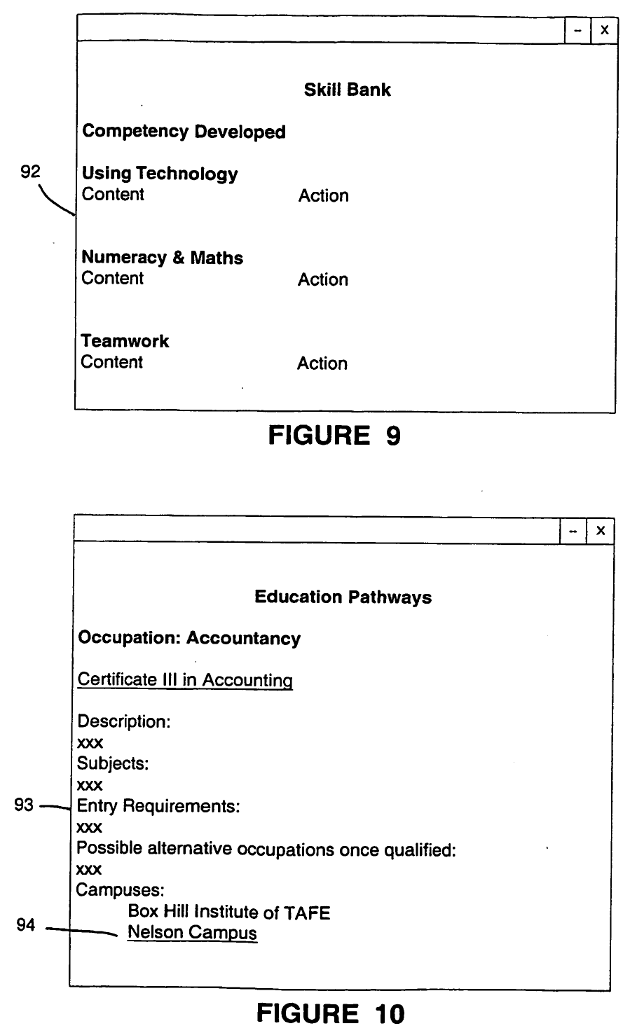

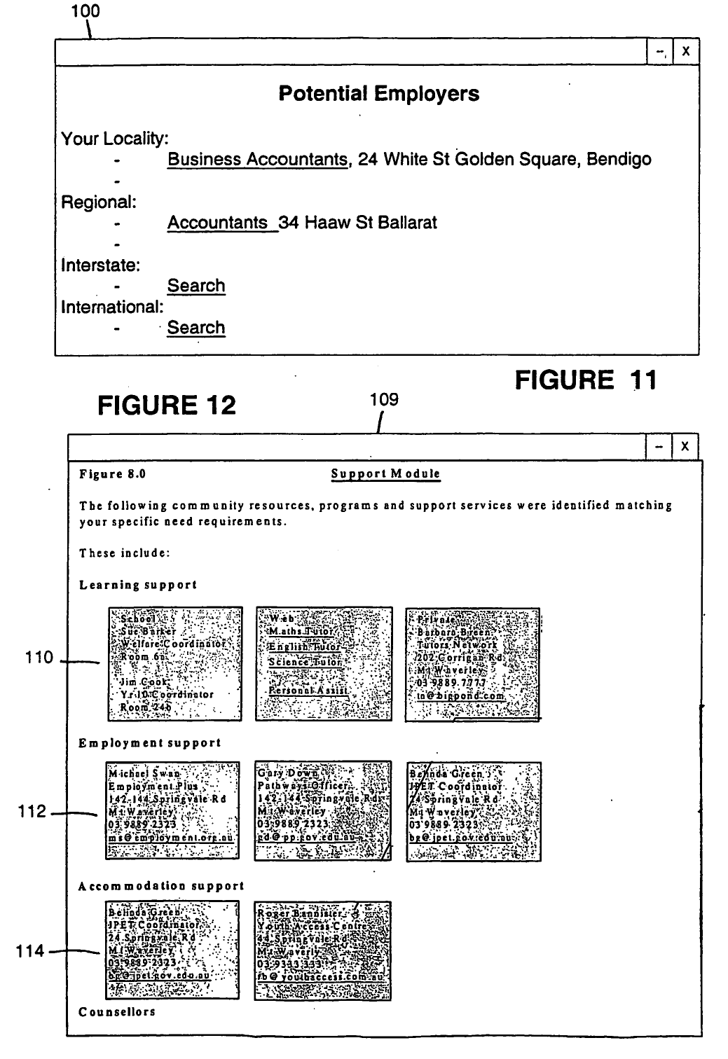

For example with reference to FIG. 7 there is shown a screen 80 with hypertext links to all of the career occupations or professions that match the personal profile of the user. The user may click on any one of the links to find out further details about that particular career. As an example by clicking on the link 82 for accountant further details are provided in the screen 84 shown in FIG. 8. Thus a description is given about the accountant position or occupation giving a job description, the key skills used in the career, the educational requirements to enter the career and possible career pathways for alternative entry. It also provides a streaming video window 86 through which a particular accountant talks about his or her career as an accountant. Thus key questions can be answered by the person giving an account of their experience as an accountant such as:

1. What do you do?

2. What do you like most about your work?

3. Is there anything that you do not like?

4. What are the opportunities in your work?

5. What suggestions would you give someone wanting to enter this career?

Thus these links provide a career exploration to the user whereby exploring, developing and understanding of the full range of careers to which a user may be suited and provides career validation which is a clarification process where the user gains a fuller understanding of what the career involves so they are able to make choices and set goals.

Referring back to FIG. 8, apart from providing the job profile and key skills of the occupation, which key skills are linked to a skill bank to be hereinafter described, there is also provided links to educational institutions that conduct the required courses in order to qualify for the occupation (where specific provider, course information, entry requirements, location, pathway options and specialist courses are provided) and lists or provides links to employers within the locality and region of the user giving information about each business, induction materials, work experience details, job offers and contact details as shown in screen 100 in FIG. 11. There is also shown associated occupations whereby links are provided to those other occupations for the user to explore and obtain information.

Shown in FIG. 9 is an example of a screen 92 in the skills bank module 128 of the performance manager module 16 which lists competencies developed for the user both generically and occupation specific. The skills bank records the development of competencies at ever increasing levels of complexity and the software module 28 uses this information to develop skills in line with the key skills of the users chosen occupation. The software module 28 also uses information from other system modules to identify work experience opportunities for the user to develop and demonstrate their skills. The skills bank is also linked to the resumé builder module 130 also to be hereinafter described.

Shown in FIG. 10 is a typical screen 93 reached by the user clicking on a hypertext link of an educational institution conducting a particular course. It provides details such as what level is required to be achieved in the course, a description of the course and subjects and the entry requirements. The entry requirements links to the software module 28 and Learning Goals function 160. Possible alternative occupations once qualified are also listed and also a link 94 provides details of the various campuses, such as Nelson Campus, that undertake the course.

Any documentation printed from sites that align each student with a number of informed occupational choices with aggregated information about the user's suitability of these occupational choices can enrich the counselling programs within a particular school. Any counsellor then has all the information to counsel the student as to appropriate courses and subjects offered at the school and the support programs to assist the student to achieve the occupational entry.

Support Module

The support module 74 links with the personal profile manager database for each user and career manager module 18 to identify existing and the most appropriate school, community services and other support agencies to best meet the user's immediate and emerging needs. Thus based on various data contained in the personal profile management database and career match module 72, data is matched to the most appropriate support agencies, an example of which is shown in FIG. 12. Screen 109 shows agencies based on search results that include available contacts for learning support at 110 providing a school contact and private contact for off-line education and also a web contact where links are provided to tutors in various subjects. Other matches are listed under employment support at 112 and accommodation support at 114 where the various scroll down boxes provide suitable contacts.

The scroll down boxes (not shown) provide a list of localised support services in each of the areas identified as needed by the user. In each category, on-line and off-line resources are provided. These are linked with the software module 28 and can be printed out for later reference. Furthermore, resource access can be tracked and measured according to utilisation.

Experience Builder Module

This module 76 has the task of identifying and providing the work experience for the user with the objectives of:

allowing the user to experience working within an occupation to enable a more informed career choice;

enable a more manageable work experience program within the school setting, linking more effectively with all of the employment and community work experience sources available and allowing students to align their career choices with work experience opportunities;

formalising the work experience program so that a prospective work experience employer has a structured program of set activities to engage the student for a number of weeks;

provide the work experience employer and student with a recognised award at the completion of the work experience program acknowledging specific levels of achievement;

providing the opportunity for small to medium employers with specific projects to advertise projects for work experience students or applicants; and

enabling those outside post compulsory education to engage in work experience with the opportunity to build a competency profile within a new occupational area.

The experience builder module 76 undertakes a search of various websites matching an occupation of interest to the user, identified to the career match module 72, and their personal profile database. Thus keywords are chosen matching the two modules and then the World Wide Web is searched based on these matches and these can be limited to a particular geographical area.

Job Finder Module

The fourth module 78 within the career manager module 18 has the task of locating job opportunities relevant to the user career profile.

This is similar to existing web-based search engines that locate employment opportunities according to specific profiles established by the user and the job finder module searches for occupations aligned with the career profile as identified by the career manager. The key difference is that by integrating the career manager and job finder better employment decisions for users and employers are possible.

These opportunities are stored on the user's website where the user will be alerted via email or SMS messages or other techniques that the user has a job opportunity stored at their website for viewing.

Performance Manager Module

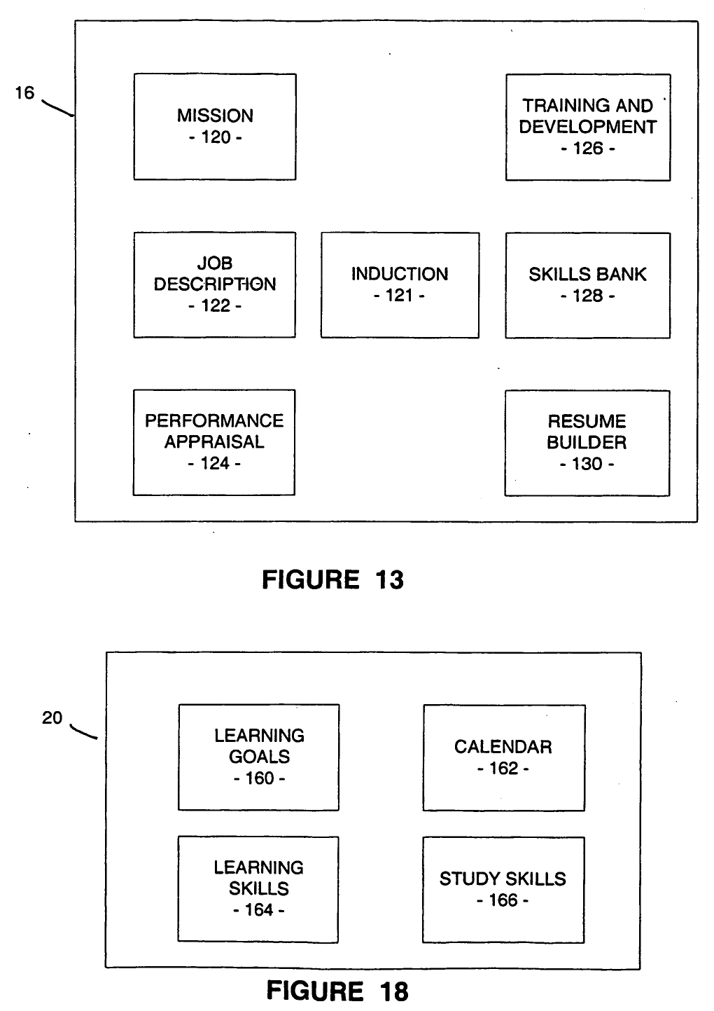

The performance manager module 16 has the key task of aligning knowledge and behaviour with purpose and mission and tracking development towards established learning and career goals. With reference to FIG. 13, it has seven modules being:

A mission module 120 which acknowledges the company/school mission statement and establishes a personal mission to guide performance. There is also an induction module 121.

A job description module 122, or in the case of a student their subject list, a performance appraisal module 124 which undertakes activities and outcomes to perform to a high standard within the job, listing role objectives and key performance indicators (KPIs). Furthermore there is a training and development module 126 identifying the experience, education and learning opportunities that align with the role objectives. There is a skills bank module 128 which stores life-long records of qualifications, experience and competencies and there is a resumé builder module 130 reflecting key skills, experience and competencies of the user. Each of these seven modules are actively linked to each of the other career and learning manager modules according to functions. Details on each of the modules are as follows:

Mission Module

This module draws together key information relating to the individual user and is essential to their performance.

The outcome of this module is a set of guiding principles that direct the efforts and performance of the user. The information is gathered through activities within this module but also collected from information from elsewhere within the system, such as the personal profile database and career manager module 18.

Upon entering the performance manager module 16, the user is directed to initially establish a mission statement by clicking on a hypertext link to the mission module 120. The mission statement is to be pertinent to the user's educational life and/or work life and is used by the software module 28 to coach individual users in self-efficacy principles through the intelligent agent. In this manner it forms an integral element in the learning and career management system for it aligns effort and ability with motivation. Thus at particular intervals the software module 28 will cause to be shown on the monitor or display of the processing means 4 of the user a particular statement to remind or instil in the user a particular statement or principle established in the mission.

Thus on constructing the personal mission statement a series of drop down boxes providing suitable choices may be presented for the user to fill in under the headings of values, principles, people the user admires, things that the user admires in others, what the user identifies him or herself as being good at, and characteristics that the user sees as impeding his or her performance or in other words, road blocks.

For example values may include status, recognition, high income whereas principles may include motivated, considerate, honest, consistent and people that the user admires may be chosen from particular subjects or areas such as education, family members or community. An example of things a user may admire in others is caring nature or people being helpful and things that the user may be good at include solving problems, writing, public speaking. Examples of road blocks or things that hinder a user's performance may be disorganisation, procrastination, getting distracted by other options such as watching TV. Once all of this data has been entered by the user the user may click a button to end the input whereupon the mission statement would then be assembled and would read as a series of statements based on the input from the user.

After completing the mission statement the software module or KAM 28 uses the self determined goals to coach the individual to remain committed to their purposes as set out in the mission statement. Additionally the mission statement can be used as a screen saver to consistently reinforce and remind the user of their personal mission.

Induction Module

This program module 121 recognises that successful performance management begins with a comprehensive and user friendly induction and orientation program. Induction is a process that is necessary upon both legislative and business levels. An induction would include making sure that employees are aware of the occupational health and safety procedures within a work place. Additionally a good induction program ensures the new employee is able to contribute productively sooner from the date of employment.

The induction module 121 provides a program that canvasses two broad areas of workplace introduction being:

1. an orientation phase, where the employee is introduced to the physical resources, policies and procedures within the workplace or new role. These may include site maps, work tools or resources, policy and procedures manual etc.

2. a socialisation phase where the employee is introduced to the supervisors, teams and fellow employees with whom they will work. This stage will also include any workplace traditions such as celebrations etc.

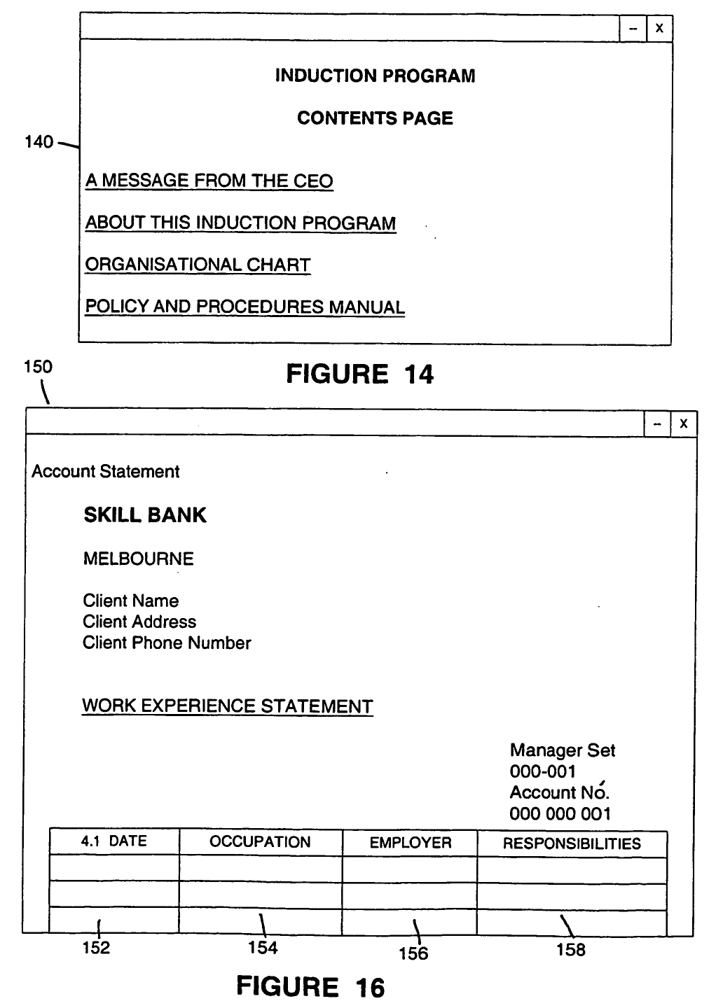

A range of induction program templates will be available providing best practice management and these will be customised according to the industry, company structure and nature of the position and other factors relevant to the specific organisation. An example of what the user will see by entering the induction module 21 is shown in FIG. 14 whereby screen 140 provides links to for example a message from the CEO, information about the induction program, an organisational chart and a policy and procedures manual.

Position or Job Description Module

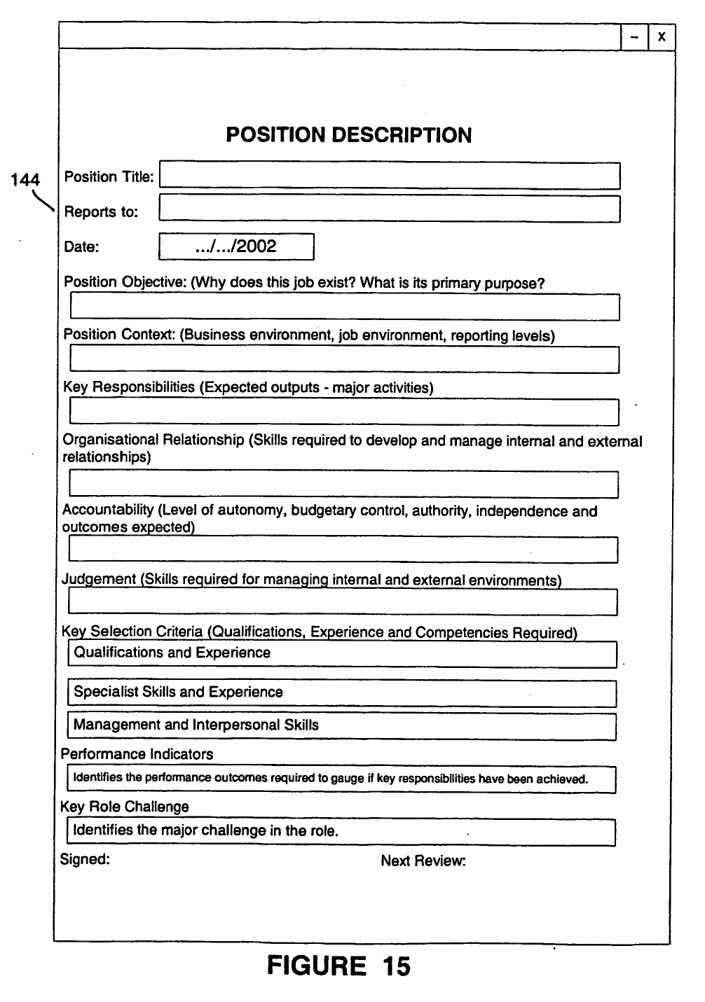

This module 122 allows the employer to design a position description and advertise it via the system website (stored on server 6) to fill a particular position. Once filled the employer and employee can work together to negotiate a role that will provide maximum utility for both parties through the position review and performance processes. A variety of different position description templates are provided to best fit the industry, position and scope of the role. An example of a position description advertised on a website and easily accessed by any user is shown on screen 144 in FIG. 15.

The benefits of the module include the following:

It assists the user by:

(a) clarifying the job description so that the user is better informed about their key responsibilities and performance criteria;

(b) assists the user to work progressively towards meeting the key objectives of the position and hence making a more structured contribution to organisational goals; and

(c) builds employability through coaching performance, developing competencies and boosting productivity outcomes.

It assists the employer by:

(a) providing a formalised template to structure and organise job descriptions so that the recruitment and employment relationship can be better managed;

(b) provide a structured process for regular revision and review of the position description ensuring its relevance to strategic goals, tasks and outcomes; and

(c) builds improved and transparent processes within the employment relationship.

Each of the boxes provide options for text input by the user in response to the headings or questions, these may include drop down boxes that can make intelligent questions as critical macros. A help icon 146, in the form of a question mark, may be clicked on to provide suggestions and examples for best practices position descriptions.

Performance Appraisal Module

This module 124 allows for regular self-appraisal (formative) and performance appraisal (summative) against established performance criteria of the position. This is seen as a critical process in developing life-long employability and competency levels. Thus the user may communicate expectations and provide feedback to employers via the software module 28. In this way there is a shared understanding of performance expectations and standards and these are reinforced via the regular appraisal feedback meetings established with the user's managers. This module is linked to a training and development module 126, to a learning goals module 160 and also to a skill bank database 128 that assist the user to maintain a record of competency based achievements wherein the employer and the employee benefit through enabling higher career achievements and hence productivity growth.

Training and Development Module

This module 126 is linked to many other modules within the system and specifically seeks out and identifies on-line and off-line training opportunities for the individual by essentially performing the work of a search engine based on keywords extracted from data input to other databases and modules, such as personal profile module and career management module. This module also utilises the program structures of the learning manager module 20, wherein the identified training programs are delivered in a methodology most conducive to the individual style of the user. Hence the training and development module 126 will provide access and coaching in both formal training, such as in university courses, on-line training courses and monitoring, and informal training such as network access, professional dialogue and mentoring.

The specific tools would include:

1. Relevant course identification. The training manager would recommend that the user consider a course in, for example, Microsoft Office® (registered trade mark of Microsoft Corp) where it is recognised that targets in the performance manager were not met.

2. Another example of the relevant course identification would be where a student has a target Enter Score of 95.5 and it is recognised that they currently require support with chemistry and so appropriate courses are identified.

3. Network contacts where users can have conference connections with a range of discussion groups in specific areas of interest. An example may be where a Cyto-geneticist wants to link in with a network of people who are publishing research to develop improved publishing skills. This would link directly to the performance manager and a suitable training and development strategy would be identified, such as linking in with “Cyto-Publishers Network”.

4. General Discussion Boards will also provide the user with regular insight into specific areas of interest.

In each group, the user is provided with a range of methods to improve their identified skill gap.

Skill Bank Module.

This module 128 maintains specific industry relevant competencies that the user develops.

For the school student, the skill bank module 128 trains them to start thinking in terms of competency and the need to prepare for the world of work via what the student can do or outcomes of behaviour rather than qualifications alone. Working with the experience builder module 76 in the career manager module, the skill bank will identify skill gaps and alert the user to filling these shortfalls so that they are best prepared for the occupational profile that they have chosen.

For example, a user may identify the occupation “systems designer” and one of the primary competencies may be “teamwork”. The user would then be coached to identify ways to develop the competency “teamwork” and to enter this into their skill bank. Competency lists would be used in the resumé builder to be hereinafter described and for job searching. An example of a skill bank screen that would be accessible on the user's own website is shown in FIG. 16. Specifically there is a screen 150 showing an account statement which has a first column 152 for entering the date of any relevant work experience conducted, a column 154 to describe the occupation, column 156 to list the employer name and column 158 to describe the responsibilities of the user in that occupation.

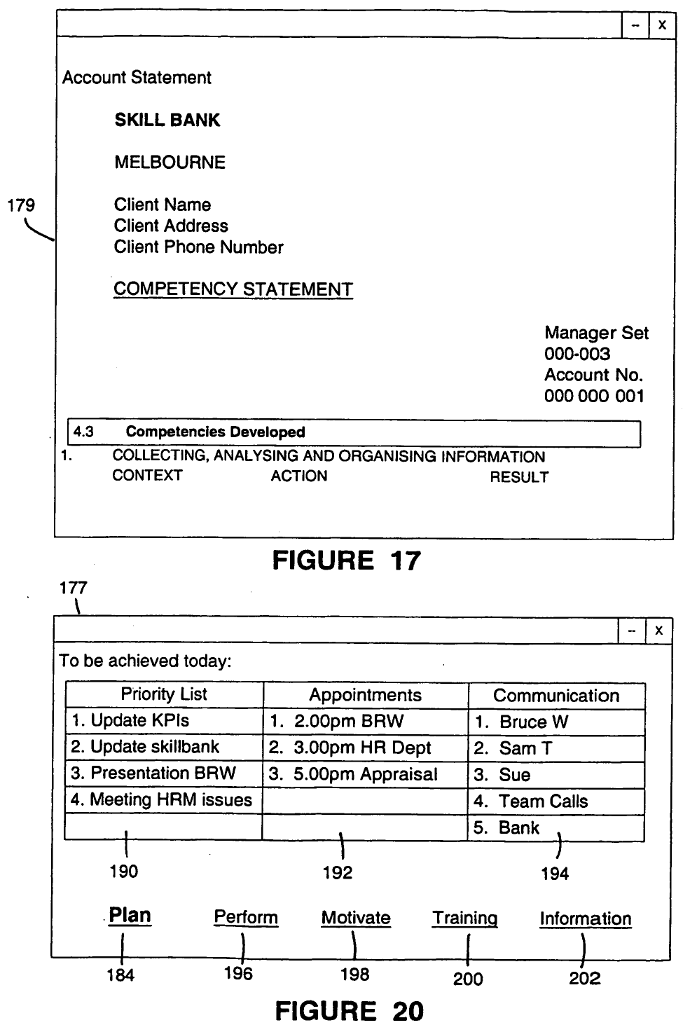

Shown in FIG. 17 is a screen 179 which is produced by the skill bank module 128 which shows the competencies that have been developed by the user.

Resumé Builder Module

The resumé builder module 130 is used to educate the user to develop and maintain a relevant resumé that is competency based and that is targeted toward the specific occupation the user wishes to enter.

The user has a choice of formats and presentation styles that will reflect their own personality and creative flair. However, the core information of key skills, experiences and competencies will be drawn from the users skill bank module 128.

On-line resumés will be searchable by employers interested in recruitment for specified positions and opportunities. Employers can also post jobs onto the jobs board that will be listed on the personal web pages of those users undergoing career transition.

Learning Manager Module

The learning manager module 20 is responsible to ensure that the growth and development needs of the individual are met through effective learning. It comprises four modules 160, 162, 164 and 166, as shown in FIG. 18, to assist an individual to organise, plan for and learn effectively.

Learning Goals Module

This module 160 has the task of coaching individuals via the software module 28 to reach the learning targets required for entry levels.

For example a user may identify the occupation “occupational therapist” and hence if they select this as their chosen occupation in the career match module 72 then the learning goals manager or module 160 will know that they need an enter score of approximately 93.5 to enter the specific university program.

The learning goals module 160 assists the individual to organise their learning program using the following steps:

1. organise the specific subjects to be undertaken

2. identify the approximate scores needed in each subject

3. assist the user to organise the assessment tasks in each subject, and

4. assist the user to approximate the score needed in each assessment task to achieve the subject level and overall target grade.

This module can quickly identify any shortfall in student performance that will enable the student to undertake supplementary programs to develop specific skills such as physics or chemistry tutoring.

Calendar Module

This module 162 assists the learner to plan their learning, advise when assignments are due, when they need to start the research and reading and where they should be up to in each of their subjects. The module will coach the user by providing messages on screen at appropriate times through the software module or KAM 28 to begin study, read prerequisite materials or write draft work, whatever the user is required to do.

The module 162 assists the user to establish a learning project management schedule after they complete a series of questions about their study schedule. This information is then used to coach their progress.

Learning Skills Module

This module 164 provides students with specific strategies and coaching to improve their learning and study skills. Information from the personal profile database is used and linked to the study program of the individual whereby relevant coaching and learning advice is delivered via the on-line learning programs through the KAM or software module 28 in the desk top management interface 26. The learning skills module is relevant for school age students and adults who are returning to a learning environment to assist them to overcome the barriers to effective learning.

Study Skills Module

The module 166 is especially designed for off-line learning and provides the know-how to maximise the effectiveness of the learning experience. The module includes a number of steps that the student must undertake, being as follows:

1. Believe in their own ability;

2. Distribute learning over a set period;

3. Organise subject matter into meaningful patterns;

4. Preview and review the subject matter;

5. Use both left and right brained approaches;

6. Test and test again

7. Overlearn

This approach can be used for exam skills whereby a series of activities are designed especially for students preparing for exams.

Learning Toolbox Module

The learning toolbox provides a range of tools to improve the on-line learning experience. The tools are designed to assist the learner in the four domains of learning, being:

exposure, absorption, retention and application.

Exposure

This tool assists on-line education providers to structure the delivery of information and present it in a way that is more easily absorbed, retained and applied by learners.

A template is provided for learning providers to present their information. The information is broken up into learning “chunks” that are more easily absorbed and relate together in a meaningful and structured pattern.

The template presents information using the following methodology:

key learning objectives,

mind map of main points and their interrelationships (preview),

required on-line/off-line reading,

recommended reading,

required on-line reading,

advisors comments (with flash glossary),

on-line activities and questions throughout text,

call-out boxes with application examples of the area in study,

knowledge tree of main points and how they relate (review),

move into action, and

review questions.

Absorption

In the learning process, after exposure the learner needs to absorb the information effectively and efficiently. The learning tool box provides a number of tools to assist learning on-line and utilising computer software. These include:

reading tools being provided to assist the learner to improve the visual intake of information on-line whereby a section of text may be increased in font size and contrasted against the background to make it easier to read;

a mind map may be used to primarily review material to enable the learner to obtain an overview of major concepts and how they relate together. Each concept within the mind map may be hyperlinked to information within the document that relates to that element;

key questions may precede the text to be read so that the user can keep in mind such questions when they are reading the text. As they develop answers to the key questions they can answer them as they go perhaps using copy and paste tools. These notes and answers form the basis of study at a later date. Additionally, when complete the learner can have their answers compared with model answers and receive feedback;

easy lookup dictionaries and thesaurus tools may be downloaded from various websites covering the specific topic areas relevant to the reader, for example medical dictionaries. This would be done through the software module which would seek out and search various dictionaries on-line;

information find tools may be used whereby a learner can mark information as they progress through their on-line readings and relate it to key concepts that later will form a subject tree. The subject tree can form the basis of research, essay writing or exam preparation.

Thus it makes it easier to find information after reading of documents;

progress reporter is a quick and easy way to gauge how much has been read and how much there is to go. For example the software module may through this tool indicate to the learner that there are a certain number of pages that have been read in the document and a certain number of pages left to read;

another function or program is the easy note taker which allows a reader to copy and paste into a virtual pad information that also records the source of the information using preset referencing guidelines. The information can be formatted according to essay or report style and forms the basic structure for later essay writing;

a knowledge linker tool links key information with other key information in set readings so that the user can develop an understanding of how different theories relate to each other;

on-line support tuition is also available with a personal tutor.

Retention

Key Learning Outcome Answers—using the key question feature outlined in the previous section, a user can revise, study and learn the content of each study module according to the pre-established learning criteria.

Knowledge Tree Hyperlink—after learning the material, information is broken down into a summarised series of memory joggers. The learner can print these out for off-line study or view them on-line where they can click on each link to revisit the information.

Examples, Stories and Case Studies provide the user with applications of the theory for improved learning and retention.

Organising Tools—using the note taker feature described in the above section, learners can format information from their reading into a variety of formats to meet assessment criteria.

A Look, Test, Check function is a study feature that displays the answer to key questions/concepts and then hides it while the learner writes the answer. The learner can then check their response compared to the answer.

Application

Exam writing is a function that can take the learner through ideal exam writing techniques.

Writing support tools—utilising the note features described above the student can format and structure information according to the assessment requirement. Information can easily be copied and pasted and will automatically reference the materials gathered. Additionally, a search can be done upon completion to determine plagiarism and students can be coached to amend this situation.

Work Application—students will be coached upon where this knowledge is applicable in their work/career and will be encouraged to undertake projects to develop work applications of their study.

Software Module known as Knowledge Application Manager (KAM) or Desktop Guru (DTG)

This software module 28 plays a central role in managing information for the user and provides the off-line support that is lacking with the existing education and career management websites. The functionality of the software is to integrate each of the various modules or programs and make key information available off-line.

Examples of how the software module would work and inter-react with the user are as follows:

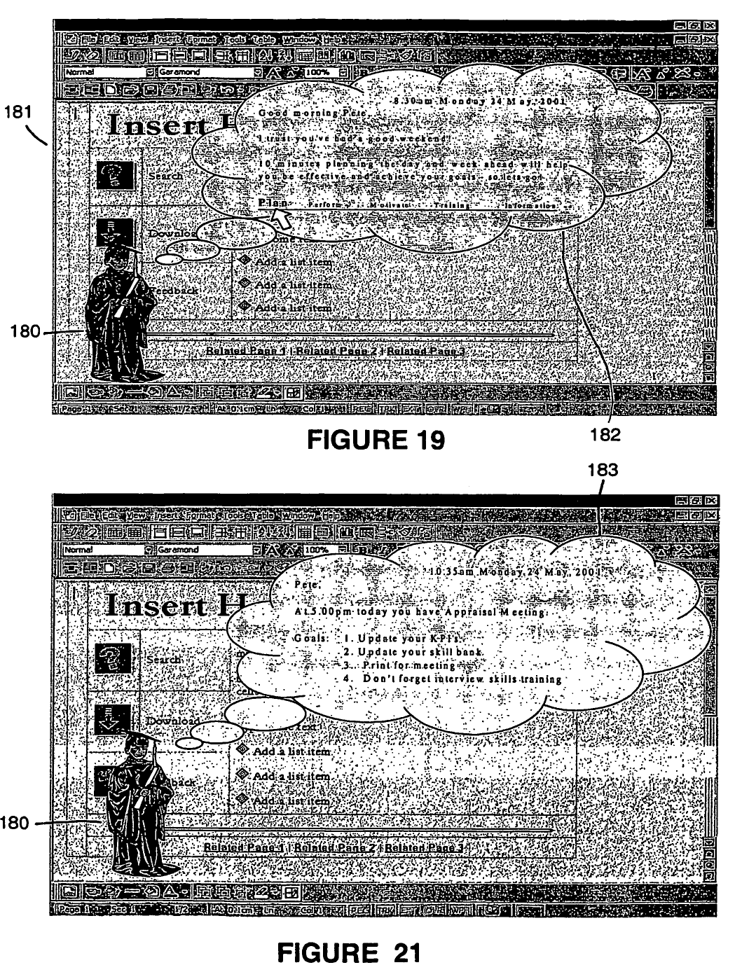

With reference to FIG. 19 there is shown a screen 181 that provides an example of a planning window shown to the user. Such a window would be the first and last activity for a student or employee each day. A desktop mentor 180 is shown reminding the user to plan the day and week ahead in a message in pop-up window 182. If the user wishes to plan then they click on the link 184 and are provided with a table shown on screen 177 in FIG. 20 whereby tasks to be achieved are prioritised in a list 190, appointment schedules made in column 192 and contacts for the user to call or otherwise see are listed in column 194. Other links are provided such as perform 196, motivate 198, training 200 and information 202. Once the user has reviewed or otherwise amended their plan for the day or week ahead they may go back to the work or web page that they were visiting. This, particular planning activity develops sound work habits as students/employees learn to plan and structure their day or week in line with their job tasks and performance management systems. The plan may be the first and last activity to do each day.

Shown in FIG. 21 is another example whereby the desktop mentor 180, through software module 28, has at a certain time, being 10.35 a.m. on a Monday, reminded the user of an appraisal meeting at 5.00 p.m. that day. Goals are listed in the pop-up window 183 to prompt the user to prepare for the appraisal meeting such as updating KPI's, updating skill bank database 128, making a print out for the meeting or agenda of the meeting and remembering the skills training that they had undertaken in preparation for interviews.

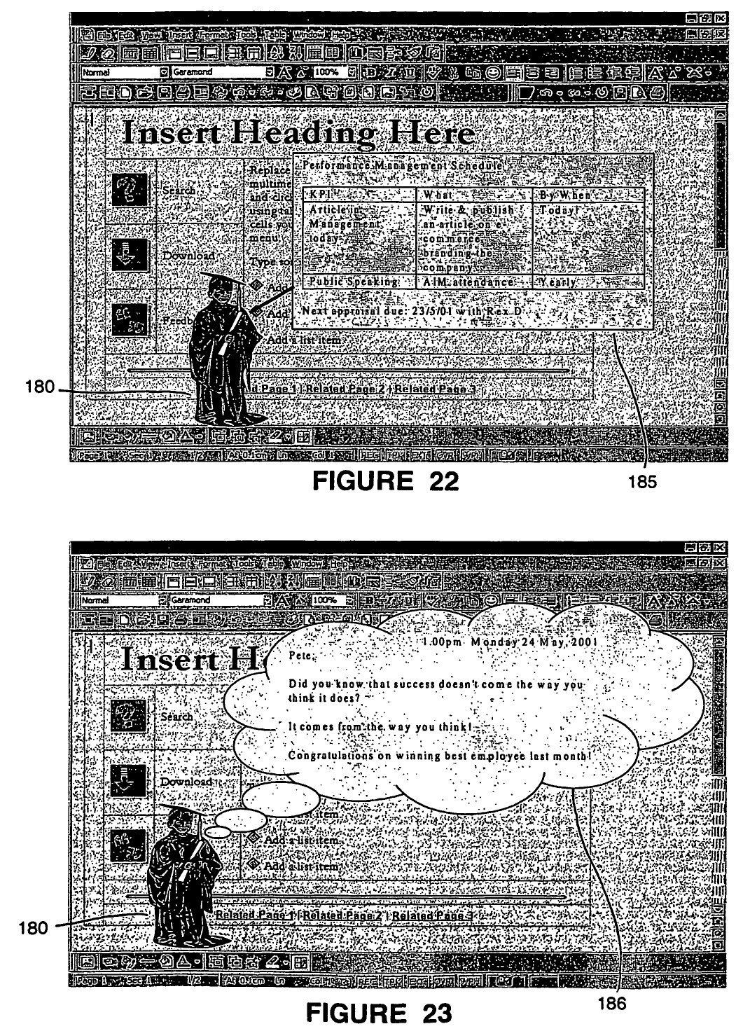

Shown in FIG. 22 is a further example of a key performance indicator or KPI which assists the user in their job or in their study. In this example a window 185 shows an article in Management Today is to be written and published dealing with e-commerce and must be done by today and also there is indicated a public speaking course which must be attended by the user on a yearly basis. A reminder is also given of when the next appraisal date is and with whom.

This particular function could be likened to an electronic version of a career portfolio where training and development is planned in line with the career goals/performance management systems already in place. Audio messages may be transmitted to the user alone or in conjunction with the visual messages.

The software module through the desktop mentor 180 may indicate to a user positive thoughts, images and expressions that can break a negative cycle that may exist in the user's workplace or in general day to day tasks. This can improve self esteem and self belief of the user. Additionally achievements can be fed back to the person so that they focus upon their strengths and not weaknesses. For example in FIG. 23 the desktop mentor 180 has produced a window 186 that provides a positive thought to the particular user.

It will also be appreciated that various modifications and alterations may be made to the preferred embodiments above, without departing from the scope and spirit of the present invention.

1. A system for providing a user with information to enhance said user's learning and development, said system comprising:
a server means connected to a communications network, said server means having memory means, processing means, and data storage means;
processing terminal means connected to said communication network for accessing said server means;
wherein computer program means stored in said memory means of said server means searches information sources for said information, said information sources being linked to said communications network and wherein said information is relevant to said user based on user personal profile data;
said user profile data including user psychometric profile data and user personal profile data; and
user electronic storage means for said user into which said information is forwarded for presentation to and accessible by said user.

2. A system according to claim 1 wherein said user profile data further includes user behaviour data.

3. A system according to claim 1, wherein said computer program means transmits one or more visual messages to said user at predetermined times to inform, remind or alert said user to information pertaining to said user's learning and development or request input from said user, on said user accessing said user electronic storage means.

4. A system according to claim 3 wherein said one or more visual messages may be transmitted to said user electronic storage means using an intelligent agent.

5. A system according to claim 4 wherein said intelligent agent manages the relevant information to assist said user to utilise, learn and take action based upon set criteria.

6. A system according to claim 1, wherein the user personal profile data includes user information such as biographical information, academic information, personal interests, and demographics.

7. A system according to claim 1 wherein said user profile data is maintained in a user profile database initiated through a personal profile module.

8. A system according to claim 7 wherein said user profile database is accessed via said user electronic storage means.

9. A system according to claim 8 wherein, in constructing, said user profile database, said computer program means causes various screens to be displayed to said user to enable said user to provide responses to statements and questions.

10. A system according to claim 9 wherein said server means stores a career manager module which is based on said user profile data and searches for suitable career options for said user using said communications network and said information sources.

11. A system according to claim 10 wherein said career manager module comprises a career match module, a support module, an experience builder module and a job finder module.

12. A system according to claim 11 wherein said career match module matches said user with occupational choices according to said user's personal profile and enables said user to access, explore and prioritise occupations matched by said career match module.

13. A system according to claim 12 wherein a message is sent to said user alerting said user to occupational choices found by said career match module.

14. A system according to claim 13 wherein said support module uses said user profile database to match appropriate support agencies, such as schools, community services and job agencies to said user.

15. A system according to claim 14 wherein said experience builder module allows said user to experience working in said occupation or a work program associated with said occupation.

16. A system according to claim 15 wherein said job finder module undertakes a search of websites matching an occupation of interest to said user identified to said career match module and in said user profile database.

17. A system according to claim 14 wherein said user is alerted when a job opportunity is found for said user, whereupon said user views said job opportunity at said user electronic storage means.

18. A system according to claim 17 wherein said server means stores a performance manager module which is based on said user profile data and tracks said user's development towards establishing learning and career goals.

19. A system according to claim 18 wherein said performance manager module includes a mission module to enable said user to establish a mission statement pertinent to said user's educational life and/or work life.

20. A system according to claim 19 wherein said computer program means uses said mission statement to train users of the system in self-efficacy principles through said intelligent agent.

21. A system according to claim 20 wherein, said computer program means, through said processing means, arranges to transmit a message to said user reminding said user of a statement or principle established in said user's mission statement.

22. A system according to claim 21 wherein said performance manager module includes an induction module to enable said user to become familiar with practice and procedures of an employer.

23. A system according to claim 22 wherein said performance manager module includes a position description module to enable an employer to design a position description and advertise said description via said communications network to fill a particular position.

24. A system according to claim 23 wherein said performance manager module further includes a performance appraisal module to enable said user to seek appraisal against established performance criteria of a position, and which lists role objectives and key performance indicators.

25. A system according to claim 24 wherein said performance manager module includes a training and development module to seek and identify on-line and off-line training opportunities for said user by searching said information sources based on said personal profile module and said careers manager module.

26. A system according to claim 25 wherein said performance manager module includes a skills bank module to record the development of competencies of said user both generically and occupation specific.

27. A system according to claim 26 wherein said performance manager module further includes a résumé builder module, linked to said skills bank module, used to educate said user to develop and maintain a résumé that is competency based and is targeted toward the occupation said user is interested in.

28. A system according to claim 27 wherein said server means stores a learning manager module which assists said user to plan and learn effectively.

29. A system according to claim 28 wherein said learning manager module includes a learning goals module for training said user, via said computer program means, to reach targets required for entry level for a particular occupation selected using said career match module.

30. A system according to claim 29 wherein said learning manager module further includes a calendar module for providing messages at predetermined times to said user, via said computer program means, to assist said user to plan and schedule said user's learning.

31. A system according to claim 30 wherein said learning manager module further includes a learning skills module to provide a user with strategies and training to improve said user's learning and study skills, said learning skills module being linked to a study program of said user.

32. A system according to claim 31 wherein said learning manager module further includes a study skills module for use by said user in an off-line environment, said study skills module including a number of steps for said user to undertake.

33. A system according to claim 32 further comprising a learning tool box module associated with said learning manager module, said learning tool box module providing said user with a range of tools to assist said user to learn how to digest information, absorb information, retain and apply said information.

34. A system according to claim 33 wherein said user electronic storage means is a website specific to said user and accessed only by said user.

35. A system according to claim 33 wherein said computer program means forms part of a desktop management interface and interacts with said website and each of said modules and databases to search, extract and process said information relevant to said user and arrange display to said user.

36. A system according to claim 35 wherein said computer program means interacts with said website and each of said modules and databases to install resource tools and said information on the desktop of said user's processing means.

37. A system according to claim 2 wherein said computer program means integrates with the other modules to provide said user with said relevant information and said one or more visual messages.

38. A system according to claim 18 wherein said performance manager module assists the user to perform any one or more of the following:
undertake induction processes;
performance appraisals;
identify personal training and development opportunities; and
develop a competency based résumé aligned with suitable career pathways.

39. A system according to claim 1 further comprising a first database means storing said user profile data.

40. A system according to claim 39 further comprising a second database means for storing locally authored content.

41. A system according to claim 40 further comprising a third database means for storing user behaviour data defining individual user usage characteristics, said data being collected and stored during user interactions with said system.

42. A system according to claim 1 further comprising a CD-ROM production means providing off-line published content to said user, such that said user accesses said published content at said user's discretion.

43. A system according to claim 1 further comprising a content syndicate engine means linked to said server means for processing and providing content to third party publishers, such as franchisees or agencies, for publication on a website of said third party publishers.

44. A system according to claim 43 wherein said content provided to said third party publishers is sent under the control of a system operator.

45. A system according to claim 41 further comprising a data mining engine means linked to said second database means and said third database means for applying analysis tools to data stored in each of said second database means and said third database means in order to determine trends and establish relationships about the stored data.

46. A system according to claim 1 wherein said communications network is the Internet.

47. A system according to claim 1 wherein said processing terminal means is a wired PC.

48. A system according to claim 1 wherein said processing terminal means includes any one of a note book computer, wireless PC, personal digital assistant or mobile telephone each linked to said communications network through a wireless communications network.

49. A method of providing information to a user to enhance their learning and development, said method using a communications network to which is linked a server means having memory means, processing means and data storage means, and a computer processing terminal means, said method comprising the steps of:
searching, via computer program means, information sources linked to said communications network for information relevant to said user which is based on a user profile data;
said user profile data including user psychometric profile data and user personal profile data;
providing said user with access to a user electronic storage means; and
storing said information in said user electronic storage means, such that on accessing said user electronic storage means, said user is presented with said information, being information that is relevant to said user's learning and development.

50. A method according to claim 49, wherein the user profile data further includes user behaviour data.

51. A method according to claim 49, further comprising the step of transmitting to said user one or more visual messages at predetermined times to inform, remind and alert said user to information pertaining to said user's learning and development or to request input from said user, when said user accesses said user electronic storage means.

52. A computer program element comprising computer program code means to control a server means to execute a procedure for providing information to a user to enhance their learning and development using a communications network by:
searching information sources linked to said communications network for information relevant to said user;
wherein said information is relevant to said user based on user profile data;
said user profile data including user psychometric profile data and user personal profile data;
providing said user with access to a user electronic storage means;
processing and storing said information in said user electronic storage means; and
presenting said information to said user, on accessing said user electronic storage means.

53. A computer readable memory, encoded with data representing a computer program for directing a server means to execute a procedure for providing information to a user to enhance their learning and development using a communications network by:
searching information sources linked to said communications network for information relevant to said user;
wherein said information is relevant to said user based on user profile data;
said user profile data including user psychometric profile data and user personal profile data;
providing said user with access to a user electronic storage means;
processing and storing said information in said user electronic storage means; and
presenting said information to said user on accessing said user electronic storage means.

54. A system for providing a user with information to enhance said user's learning and development, said system comprising:
a server connected to a communications network, said server having a memory, a processor, and a data storage;
a processing terminal connected to said communication network for accessing said server;
wherein a computer program stored in said memory of said server searches information sources for said information, said information sources being linked to said communications network and wherein said information is relevant to said user based on user personal profile data;
said user profile data including user psychometric profile data and user personal profile data; and
user electronic storage means for said user into which said information is forwarded for presentation to and accessible by said user.

55. A method of providing information to a user to enhance their learning and development, said method using a communications network to which is linked a server having a memory, a processor and a data storage, and a computer processing terminal, said method comprising the steps of:
searching, via a computer programs, information sources linked to said communications network for information relevant to said user which is based on a user profile data;
said user profile data including user psychometric profile data and user personal profile data;
providing said user with access to a user electronic storage; and
storing said information in said user electronic storage, such that on accessing said user electronic storage, said user is presented with said information, being information that is relevant to said user's learning and development.
